(19) United States
(12) Patent Application Publication
(10) Pub. No.: US 2024/0133819 A1
(43) Pub. Date: Apr. 25, 2024

(54) Methods for Analyzing an Electrode Layer of a Battery Cell Using a KI Engine, Training a KI Engine, Producing a Battery Storage Device, and Production Units

(71) Applicant: Siemens Aktiengesellschaft, München (DE)

(72) Inventors: Sascha Schulte, Höchstadt (DE); Manfred Baldauf, Erlangen (DE)

(73) Assignee: Siemens Aktiengesellschaft, München (DE)

(21) Appl. No.: 18/547,305

(22) PCT Filed: Feb. 1, 2022
(86) PCT No.: PCT/EP2022/052283

§ 371 Date: Aug. 20, 2023

(30) Foreign Application Priority Data
Feb. 26, 2021 (EP) 21159596.2
Mar. 15, 2021 (EP) 21162908.4

(51) Int. Cl. G01N 21/84; G01N 21/01; G01N 21/88

(52) U.S. Cl. CPC G01N 21/8422; G01N 21/01; G01N 21/8806; G01N 2021/0181; G01N 2021/8845

(57) ABSTRACT

Various embodiments of the teachings herein include a method for analyzing an electrode paste and/or an electrode layer for a battery cell. The method may include: measuring a property of the electrode layer paste and/or the electrode layer using a measuring facility; generating measurement data; and determining a quality value of the electrode layer paste and/or the electrode layer using an AI engine based on the measurement data.

### CROSS-REFERENCE TO RELATED APPLICATIONS

This application is a U.S. National Stage Application of International Application No. PCT/EP2022/052283 filed Feb. 1, 2022, which designates the United States of America, and claims priority to EP Application No. 21162908.4 filed Mar. 16, 2021 and EP Application No. 21159596.2 filed on Feb. 26, 2021, the contents of which are hereby incorporated by reference in their entirety.

### TECHNICAL FIELD

The present disclosure relates to batteries. Various embodiments of the teachings herein include methods for analyzing an electrode layer paste and/or an electrode layer, methods for training an AI engine, methods for producing a battery storage device, production units, and/or computer program products.

### BACKGROUND

Lithium-ion accumulators, hereinafter also referred to as lithium-ion batteries, are used as energy stores in mobile and stationary applications due to their high power density and energy density. A lithium-ion battery typically comprises multiple battery cells. A battery cell, in particular a lithium-ion battery cell, comprises a multiplicity of layers. Typically, these layers comprise anodes, cathodes, separators and other elements. These layers can be designed as stacks or as windings.

The electrodes usually comprise metal foils, in particular comprising copper and/or aluminum, which are coated with an active material. A lithium compound or carbon-containing paste, called a slurry, is typically applied as the active material. The foils and the coating each have a thickness of a few micrometers. Even a few micrometers of deviation in the thickness of the coating or in the material composition can have negative effects on the quality of the electrode. A disadvantage of irregular coating is the production of battery cells of inferior quality. Furthermore, safe operation of the battery cell is not ensured.

Currently, faulty coatings can often only be identified after completion of the entire production process of the battery cell in the context of a so-called end-of-line test. In some cases, faulty coatings are only detected after several years of operation of the battery cell. A large proportion of scrap of faulty battery cells is thus generated during battery production. Thus, the production process has a large material and energy requirement to produce a sufficient amount of high-quality battery cells.

### SUMMARY

Teachings of the present disclosure provide methods and/or systems for analysis during production, production methods for a battery storage device, production units, and computer program products which reduce the reject rate of battery production. For example, some embodiments include a method for analyzing an electrode paste and/or an electrode layer (4) for a battery cell (50) including: provision of at least one measuring facility for measuring a property of the electrode layer paste (2) and/or the electrode layer (4) during a production method, measurement of the property of the electrode layer paste (2) and/or the electrode layer (4) and generation of measurement data by means of the measuring facility, provision of an AI engine (111), and determination of a quality value of the electrode layer paste (2) and/or the electrode layer (4) by means of the AI engine (111) based on the measurement data.

In some embodiments, at least two measuring facilities are used and a first property of the electrode layer paste (2) and/or the electrode layer (4) is determined with a first measuring facility and a second property of the electrode layer paste (2) and/or the electrode layer (4) is determined with a second measuring facility.

In some embodiments, a first quality value is determined as a quality value as a degree of mixing, a relief value, a porosity and/or a crack value of the electrode layer (4).

In some embodiments, a relief value is determined in at least two locations of the electrode layer (4) and based thereon a shape of at least one depression and/or a number of depressions of the electrode layer (4) are determined.

In some embodiments, a second quality value is determined as a quality value as an aging behavior, a capacitance, an operating voltage, a quiescent voltage and/or an internal resistance of the battery cell (50).

In some embodiments, a laser scanning facility (5) is used as the measuring facility for determining a topological property as a property of the electrode layer (4).

In some embodiments, a porosity measuring facility (9), in particular an ultrasonic measuring unit, an X-ray method or a computer tomograph, is used as the measuring facility for measuring a porosity value of the electrode layer (4).

In some embodiments, a porosity and/or a pore density and/or a pore distribution and/or a pore volume is determined as the porosity value.

In some embodiments, for training of the AI engine (111): after measuring the property, the electrode layer (4) is introduced into a battery cell (50), the battery cell (50) is put into operation, and operating data of the battery cell (50) is determined, this operating data is correlated with the property of the electrode layer paste (2) and/or the electrode layer (4).

In some embodiments, two properties of the electrode layer are determined and the first property and the second property are assigned location information during measurement and a comparative value is determined at a location (El), wherein the comparative value is included in the correlation determination of the AI engine during training.

In some embodiments, the AI engine (111) is trained using deep-learning methods to perform an evaluation of the electrode layer (4), wherein the quality value is divided into quality classes and a quality class is assigned to a location of the electrode layer (4).

As another example, some embodiments include a method for producing a battery storage device including: analysis of an electrode layer paste and/or an electrode layer (4) for a battery cell (50) of the battery storage device according to one or more of the computer-aided methods as described herein, wherein an AI engine has been trained in particular as described herein, and adjustment of at least one production condition for producing the electrode layer (4) based on at least one quality value.

In some embodiments, temperatures, solvent content of the electrode layer paste, a degree of mixing of the electrode layer paste and/or an application rate of the electrode layer paste (2) to a carrier substrate (3) are adjusted as production conditions.

As another example, some embodiments include a production unit (1) for producing a battery store (50) comprising: an electrode layer production facility (8) with at least one measuring facility, an AI engine (111) set up to carry out one or more of the methods as described herein.

As another example, some embodiments include a computer program product which can be loaded directly into a memory of a programmable computing unit, having program code means for carrying out one or more of the methods as described herein when the computer program product is executed in the AI engine (111).

### BRIEF DESCRIPTION OF THE DRAWINGS

Further features, properties, and advantages of the teachings of the present disclosure will emerge from the description which follows with reference to the accompanying figures. In these diagrammatic views,

FIG. 1 shows a production unit with an electrode layer production facility with a laser scanning facility, a porosity measuring facility and an AI engine incorporating teachings of the present disclosure;

FIG. 2 shows an electrode layer production facility and two battery cells incorporating teachings of the present disclosure; and

FIG. 3 shows a process diagram for analyzing an electrode layer for a battery cell incorporating teachings of the present disclosure.

### DETAILED DESCRIPTION

In some embodiments of the teachings herein, at least one measuring facility is provided for measuring a property of the electrode layer paste and/or the electrode layer during a production method.

The property of the electrode layer paste and/or the electrode layer is measured, and measurement data is generated by means of the measuring facility. Furthermore, an AI engine is provided. By means of the AI engine, a quality value of the electrode layer paste and/or the electrode layer is ascertained based on the measurement data.

The electrode layer is introduced into a battery cell after measuring the property. The battery cell is put into operation. Operating data of the battery cell is ascertained. The operating data of the battery cell is correlated with the property of the electrode layer and/or the electrode layer paste. Based on this correlation, the quality value is ascertained.

An example production method incorporating teachings of the present disclosure includes an electrode layer paste and/or an electrode layer for a battery cell of the battery storage device is analyzed according to one or more of the methods for analyzing the electrode layers described herein. A production condition for producing the electrode layer is adjusted based on at least one quality value.

In some embodiments, an electrode layer for the battery storage device is analyzed according to one or more of the methods described herein for analyzing the electrode layer. The AI engine used in the computer-aided method for analysis was trained in particular according to one or more of the methods described herein for training the AI engine. A production condition for producing the electrode layer is adjusted based on at least one first quality value.

An example production unit incorporating teachings of the present disclosure for producing a battery storage device comprises an electrode layer production facility with a measuring facility and with an AI engine, which is designed to carry out one or more of the methods described herein for analysis.

An example computer program product incorporating teachings of the present disclosure can be loaded directly into a memory of a programmable computing unit, comprises program code means for carrying out one or more of the methods described herein for analysis when the computer program product is executed in the computing unit.

In connection with the present disclosure, an AI engine can be understood to mean a computer system which comprises an “application”, e.g. an executable file or also a program library, which learns, in particular, correlations of different input data by means of artificial intelligence (AI).

The AI engine has an execution environment. In connection with the patent application, an execution environment can be understood to mean a virtual machine, for example a Java virtual machine, a processor, or an operating system environment. The execution environment can be implemented on a physical computing unit (processor, microcontroller, CPU, CPU core). In this case, the application can be executed in a learning mode and in an execution mode on the same physical computing unit. It is also possible, for example, for the application to be executed in a learning mode in another physical computing unit. For example, the learning can take place in a special training computing unit. Execution in an execution mode takes place, for example, in a second computing unit, the validity information determined during training being used in the execution in the computing unit. The validity information determined by the training computing unit, for example, is provided in a manipulation-proof manner.

Electrode layer paste (slurry) means the raw substance for producing the electrode layer.

In some embodiments, the method already records at least one property of the electrode layer paste and/or the electrode layer during production by means of the measuring facility. In other words, the electrode layer paste and/or the electrode layer are analyzed online, without the need for direct physical intervention in the electrode layer.

The quality value is thus not only determined based on individual limit values for individual production steps, in particular the application of the electrode layer to a substrate and/or the electrode layer properties, but operating values of the completely manufactured battery cells are included in the evaluation of the quality value. In other words, as an alternative or in addition to limit values, which are specified in individual production steps, the quality value includes whether the analyzed properties of the electrode layer paste and/or the electrode layer are related to high-quality operating data. In particular, during the training of the AI engine, not only a limit value for a specified property is observed, but the interaction of the individual properties and the sequence on the operating data is analyzed.

In other words, the quality value includes the measurement data and an evaluation of the measurement data based on a correlation of the measurement data with the operating data.

Operating data means, in particular, quiescent or operating voltage, current, internal resistance and/or capacitance of the battery during operation. In other words, operating data can represent a second quality value.

These relationships can be surprising to a person skilled in the art. It is possible that limit values for individual production steps are exceeded, but the quality value is still sufficiently good. It is also possible that the individual production steps are within predetermined limit values, but the quality value is nevertheless to be rated as insufficient as small deviations from one production step to the next production step add up. By training the AI engine, it is possible to determine the quality value at an early stage during the production method if the trained AI engine in used in a production method for the analysis of the electrode layer paste and/or electrode layer. Thus, it can be detected at any early stage if the quality of the electrode layer deteriorates.

It is also possible to determine an item of information which goes beyond an output of “electrode layer is OK” or “electrode layer is a reject”. It can thus be assessed whether the electrode layer is of sufficient quality to be installed in a battery cell. Furthermore, it is possible to determine by means of the deviating quality value which of the production conditions are to be adapted in order to improve the quality of the electrode layer.

In some embodiments, at least two measuring facilities are used, and a first measuring facility is used to determine a first property of the electrode layer paste and/or the electrode layer, and a second measuring facility is used to determine a second property of the electrode layer paste and/or the electrode layer. A larger number of different measured values are thus included in the determination of the quality value. This enables a determination of the quality value which is more robust and reliable.

In some embodiments, the first property and the second property are assigned location information during measurement. A comparative value is determined at one location. The comparative value is included in the correlation determination of the AI engine during training. Thus, information about precisely one location of the electrode layer can be merged. In some embodiments, it is thus possible to analyze conclusions about the shapes of holes or cracks in the electrode layer. It is in turn possible to infer possible incorrectly adjusted production apparatuses, in particular apparatuses for applying the electrode layer paste onto a carrier substrate. These incorrectly adjusted production apparatuses can subsequently be corrected.

In some embodiments, the AI engine is trained by means of deep learning methods to divide the first quality value into quality classes and to assign a location of the electrode layer to a quality class. It is thus possible to analyze the electrode layer in a spatially resolved manner. A qualitatively inferior section of the electrode layer can then be discarded in a targeted manner. An inferior electrode layer is therefore not installed in the one battery cell, which would then function unreliably and lead to rejects.

In some embodiments, a laser scanning facility for determining a topological property as a property of the electrode layer is used as the measuring facility. Thus, an image of the electrode layer is recorded with a laser scanning facility. Topological properties of the electrode layer are determined based on the image information. A correlation of the topological properties of the electrode layers with the operating data of the battery cell already enables an evaluation of the electrode layer during the production method.

In some embodiments, a porosity measuring facility, in particular an ultrasonic measuring unit or a computer tomograph, is used as a measuring facility for measuring a porosity value of the electrode layer. By means of the analysis of the topological properties of the electrode layer, with the analysis of the porosity of the electrode layer and/or with a combination of both measurement methods, wherein the measured values are then determined in a spatially resolved manner at the same location, it is possible to analyze whether there are cracks in the electrode layer and, if so, whether these cracks correlate with a particularly low coating thickness and/or a high porosity. It is thus possible to determine information which goes beyond an output of “electrode layer is OK” or “electrode layer is a reject”. It is thus possible to assess whether the electrode layer is of sufficient quality to be installed in a battery cell. Furthermore, the first quality value can be used to draw conclusions about possible faulty production process steps.

In some embodiments, a relief value is determined for at least two locations in the electrode layer based on a comparative value and at least one property of the electrode layer paste and/or electrode layer. Based thereon, at least one shape of at least one depression and/or number of depressions is determined based on the at least one relief value. It is thus possible to analyze whether cracks, punctiform holes or fluctuations in the coating thickness are present in the electrode layer, in particular. The electrode layer can thus be analyzed in a very differentiated manner during the production process. Based on this information, it can be assessed at an early stage whether the electrode layer is of sufficiently high quality to be installed in a battery cell. In other words, the first quality value also includes how the shape of the depressions is structured, the different shapes being evaluated with regard to an influence on the quality of the electrode layer, in particular by means of tolerance limit values.

In some embodiments, an ultrasonic measuring unit or an X-ray-based measurement method, in particular a computer tomograph, is used as the porosity measuring facility. The porosity can be determined in a contactless manner during the production process by means of this measurement method. It is also possible, by means of the X-ray methods, to determine a structure of the electrode layer after the production process in order to verify the structure which was measured with the optical methods.

In some embodiments, a hyperspectral camera and/or a dielectric spectroscopy unit are used as a measuring facility. Based on the image data, the hyperspectral camera can be used to determine, in particular, a chemical composition of the electrode layer as a property. The dielectric spectroscopy unit can be used to determine, in particular, dielectric properties as a property.

In some embodiments, a first quality value, in particular a degree of mixing, a relief value and/or a crack value of the electrode layer is determined as a quality value. These variables advantageously represent a quality of the electrode layer.

In some embodiments, a second quality value, in particular an aging behavior, a capacitance, a quiescent voltage, an operating voltage and/or an internal resistance of the battery cell and/or of the battery storage device with the battery cell is used as a quality value. In other words, the battery data, which is determined as operating data by means of measurements, is regarded as a second quality value.

In some embodiments, a porosity and/or a pore density and/or a pore distribution and/or a pore volume is determined as the porosity value. It is thus possible to evaluate the porosity on the basis of different methods and to combine these results if necessary.

In some embodiments, temperatures of the solutions and/or temperatures of the environment, solvent content in the raw electrode solution for the electrode layer, and/or the degree of mixing of the raw electrode solution are adjusted as production conditions. An adjustment takes place in such a way that the first quality value and/or the second quality value is improved.

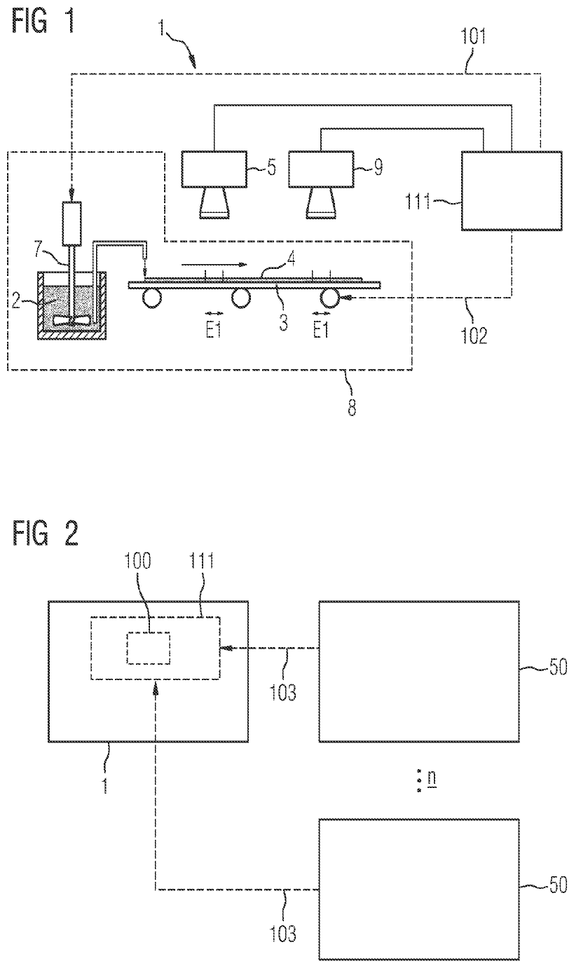

FIG. 1 shows an example production unit 1 incorporating teachings of the present disclosure. The production unit 1 comprises an electrode layer production facility 8. The electrode layer production facility 8 comprises two measuring facilities: as a first measuring facility, a laser scanning facility 5, as a second measuring facility, a porosity measuring facility 9. It also comprises an AI engine 111, 100. The AI engine 111 is connected to the laser scanning facility 5 and the porosity measuring facility 9 via a data cable. The electrode layer production facility 8 comprises a carrier substrate 3 onto which an electrode layer 4 made of an electrode layer paste 2 (slurry) is applied. The electrode layer paste 2 is homogenized in a container by means of an agitator 7. The agitator 7 and the substrate transport are likewise connected to the AI engine 111 via a data cable.

In this example, at least one image of the electrode layer 4 and location information El are recorded with the laser scanning facility 5 as one property. Furthermore, a second property, namely a porosity and/or an electrode layer thickness of the electrode layer 4, is determined by means of the porosity measuring facility 9. In this example, the analysis is carried out at the same location of the electrode layer 4 after the substrate with the electrode layer 4 has been transported further, now characterized by the location information El′. The analysis of the porosity takes place during the production of the electrode layer 4. The porosity measuring facility is then configured in particular as an ultrasonic measuring unit, as an X-ray absorption unit or as a computer tomograph.

In this example, the measurement data is transmitted to the AI engine 111. In the AI engine 111, the topological properties of the electrode layer 4 are then determined based on at least one image as a function of the location information El. The topological properties, in other words, a three-dimensional image of the electrode layer surface, are then compared with the porosity value and/or the electrode layer thickness at this location. In this example, a comparative value is determined based on the comparison. However, it is likewise possible to consider the two properties separately.

Based on this comparative value, a first quality value of the electrode layer is determined. In particular, a degree of mixing of the electrode layer 4 or a roughness of the electrode layer 4 is determined as the first quality value.

The quality value is determined by means of the AI engine 111, as shown in FIG. 2. For example, the AI engine 111 is a computer system having a computing unit 100. The AI engine 111 is trained by means of operating data from battery cells 50 into which the electrode layers 4 have been introduced: based on the operating data, the quality value is determined. In doing so, the AI engine 111 is trained to correlate the operating data with the individual properties, in this example the porosity and the topological property, and/or with the comparative value and to determine a quality value.

In particular, this quality value can provide information about the production process. In particular, it is possible to analyze how disturbances are distributed relative to one another and how their position is relative to one another. In particular, it is possible to analyze whether there are cracks particularly often in the range of low coating thicknesses. Furthermore, it is possible to analyze, in particular, whether the porosity is high when a high number of holes are limited to a local position of the electrode layer. In the latter case, the coating facility may need to be readjusted.

In order to train the AI engine 111, an additional determination of the porosity can also take place. In particular, an external determination of the porosity can be carried out, in particular by means of optical methods from sectional images or gas porosimetries. The results of this porosity determination can be compared with the results of the online method of porosity determination. Furthermore, additional information about the electrode layer 4, in particular conclusions about the internal structure, such as grain size distribution or grain boundaries, can be determined.

By using the trained AI engine, it is possible to determine a quality value based on individual properties or based on the comparative value, which is determined based on the image data of the laser scanning facility, the porosity and/or the electrode layer thickness. Advantageously, operating data from battery storage devices can be included without each electrode layer already having to be installed in a battery cell.

Furthermore, porosity values measured offline can be correlated with porosity values measured online in order to further optimize an evaluation of the electrode layer 4 by means of the AI engine. In other words, based on the comparative value, statements can also be made about the internal structure of the electrode layer 4, in particular about grain size distributions or grain boundaries, without having to carry out an offline determination of the porosity.

Based on this quality value, the production conditions of the production unit 1 can be adjusted, as already shown in the first exemplary embodiment. In this example, the agitator 7 of the electrode raw solution 2 is adjusted by means of a second control signal 102 and/or the running speed of the electrode substrate 3 is adjusted by means of a first control signal 101.

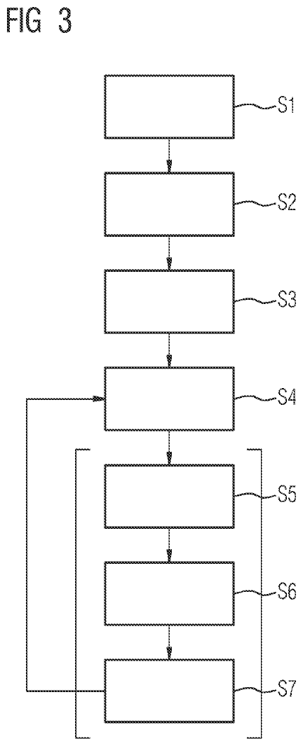

FIG. 3 shows a diagrammatic view of the method for analyzing an electrode layer paste 2 and/or an electrode layer 4 of a battery cell 50 in an electrode layer production facility 1.

In a first step S1, at least one measuring facility for measuring a property of an electrode layer paste 2 and/or an electrode layer 4 is provided. In a second step S2, the property of the electrode layer paste 2 and/or the electrode layer is measured and measurement data is generated by means of the measuring facility. In a third step S3, an AI engine 111 is provided. In a fourth step S4, a first quality value of the electrode layer paste 2 and/or the electrode layer 4 is determined by means of the AI engine. In a fifth step S5, the AI engine is trained. For this purpose, in a sixth step S6, the electrode layer is introduced into a battery cell after measuring the property. The battery cell is put into operation and the operating data is determined. In a seventh step S7, the operating data is correlated with the property of the electrode layer paste 2 and/or the electrode layer 4.

By means of the trained AI engine 111, the first quality value of the electrode layer 4 can then be determined as a function of the comparative value, without the electrode layer 4 having to be installed in battery cell 50.

In some embodiments, the production unit comprises an electrode layer production facility, a hyperspectral camera as a measurement sensor and an AI engine. The electrode layer production facility comprises a carrier substrate onto which an electrode layer made of an electrode layer paste (slurry) is applied. The electrode layer paste is homogenized in a container by means of an agitator.

The hyperspectral camera takes an image with at least two pixels of the electrode layer. The two pixels are located at mutually adjacent locations. Based on the pixels, a material property of the electrode layer can be determined by means of the AI engine. In this example, the evaluation of the material composition as a material property is based on the image data. The material compositions, which were determined at the two adjacent locations, are combined to form a comparative value. This comparative value can be, in particular, a concentration gradient of a defined material composition and/or a concentration gradient of a defined component of the electrode layer paste, also referred to as the electrode raw solution. Based on this comparative value, a characteristic property can then be determined. A characteristic property in this example is a material composition gradient. Based on this material composition gradient, in particular a material homogeneity value can also be determined.

The AI engine was also trained in this example by means of operating data from the battery cell into which the electrode layers were introduced. Based on the operating data, a quality value can be determined, the AI engine being trained to correlate the quality value with the characteristic property.

Thus, by using the trained AI engine, it is possible to determine a quality value based on the characteristic property, which is analyzed by means of the hyperspectral camera and the recorded image. Based on this quality value, production conditions of the production unit can now be adjusted. In this example, the agitator of the electrode layer paste is adjusted by means of a second control signal and/or the running speed of the electrode substrate by means of a first control signal.

Furthermore, it is possible to determine material composition gradients and/or layer thicknesses on the basis of a comparison of the adjacent image recordings. On the basis of this evaluation, it is advantageously possible to determine where defects, such as in particular cracks and/or inclusions, are present in the electrode layer.

In some embodiments, two dielectric spectroscopy units are arranged in the production unit as measuring facilities. The production unit comprises an electrode layer production facility and an AI engine. The electrode layer production facility comprises a carrier substrate onto which an electrode layer made of an electrode layer paste (slurry) is applied. The electrode layer paste for the electrode layer is homogenized in a mixing container by means of an agitator.

A first dielectric spectroscopy unit is arranged in the mixing container. In this example, the first dielectric spectroscopy unit is located at the edge area of the mixing container. Alternatively, it is also conceivable to arrange the dielectric spectroscopy unit centrally in the mixing container or at locations such as the dead spaces in the corners of the mixing container.

The electrode layer paste is applied to the carrier substrate via a first line. In this example, a second dielectric spectroscopy unit is arranged in the first line. This ensures that the entire electrode layer paste is analyzed before it is applied to the carrier substrate.

The determined measurement data is transmitted to the AI engine via data lines. In the AI engine, a first quality value, which in particular describes the conductivity or the homogeneity of the electrode layer paste, is determined.

The AI engine is trained by means of operating data from battery cells into which the electrode layers were introduced. The quality value can be determined on the basis of the operating data. For this purpose, the operating data is combined with the dielectric property of the electrode layer paste or the time profile of the electric property to form a comparative value. A quality value is then assigned to the comparative value by the AI engine. In other words, after having been trained with operating data from battery cells (or battery storage devices comprising the battery cells), the AI engine can make statements about the quality of the dielectric properties such as, in particular, the conductivity or homogeneity value of the electrode layer paste.

It is thus possible to make statements about the quality of the electrode layer and/or the subsequent quality of the battery cells at a very early stage, namely during the production method, by using the AI engine. As a results of the analysis, it is then possible to intervene in the production method. In some embodiments, it is possible to discard electrode layers which were produced from the electrode layer paste and do not meet the requirements of the first and/or second quality value in order to minimize the rejection of the battery cells.

Operating data from battery cells can be included in the determination of the first quality value without each electrode layer already having to be installed in a battery cell.

The selection of technical parameters of the dielectric spectroscopy unit, such as in particular accommodation of the sensor in electrically insulating protective elements, the use of different measurement frequencies, or the choice of electrode shape, can enable a measurement of different technical properties of the slurry to be examined. In particular, the electrical insulation of the electrodes of the spectroscopy unit allows the use of a conductive medium. Furthermore, the variation of the measurement frequency of the dielectric spectroscopy unit allows a measurement which is comparable to electroimpedance spectroscopy in certain frequency ranges. For both sensors, a response of the system to be measured to electrical oscillation excitation at different frequencies is analyzed. In electroimpedance spectroscopy, however, the complete impedance, in other words including the current conductivity, of a finished battery cell is typically determined in the prior art.

When measuring the slurry with the electrical spectroscopy unit, as shown in this first example, a change in the dielectric properties of the electrode layer paste is already determined during the production method. The production conditions can still be changed in this case.

By using the dielectric spectroscopy unit, it can also be determined whether the materials of the raw suspension have not only been mixed, but also mechanically damaged. Depending on the selected measurement frequency of the spectroscopy unit, this may result in a change in the excitation response, i.e. the electrical properties of the raw suspension.

The measurement units mentioned in the examples, the laser scanning unit, the porosimetry unit, the hyperspectral camera and the dielectric spectroscopy unit, can also be used in a production unit and all provide measurement data for an AI engine. Advantageously, this increases the robustness of the evaluation of the first quality value of the electrode layer.

Although the teachings herein have been illustrated and described in more detail by the exemplary embodiments, the scope of the disclosure is not limited by the disclosed examples. Variations thereof may be derived by a person skilled in the art without departing from the scope as defined by the following claims.

### LIST OF REFERENCE CHARACTERS

1 Production unit
2 Electrode layer paste (slurry)
3 Carrier substrate
4 Electrode layer
5 Laser scanning facility
7 Agitator
8 Electrode layer production facility
9 Porosity measuring facility
50 Battery cell
100 Computing unit
101 First control signal
102 Second control signal
103 Operating data
111 AI engine
S1 Provision of at least one measuring facility for measuring a property of an electrode layer paste and/or an electrode layer
S2 Measurement of the property of the electrode layer paste and/or the electrode layer and generation of measurement data by means of the measuring facility
S3 Provision of an AI engine
S4 Determination of a first quality value of the electrode layer paste and/or the electrode layer by means of the AI engine
S5 Training of the AI engine
S6 Introduction of the electrode layer into a battery cell after measurement, commissioning of the battery cell and determination of operating data
S7 Correlation of the operating data with the property of the electrode layer paste and/or the electrode layer

What is claimed is:

1. A method for analyzing an electrode paste and/or an electrode layer for a battery cell, the method comprising:
measuring a property of the electrode layer paste and/or the electrode layer using a measuring facility;
generating measurement data; and
determining
a quality value of the electrode layer paste and/or the electrode layer using an AI engine based on the measurement data.

2. The method as claimed in claim 1, further comprising measuring a second property using a second measuring facility.

3. The method as claimed in claim 1, wherein the quality value measures a degree of mixing, a relief value, a porosity, and/or a crack value of the electrode layer.

4. The method as claimed in claim 3, further comprising:
determining a relief value in at least two locations of the electrode layer; and
based thereon, determining a shape of at least one depression and/or a number of depressions of the electrode layer.

5. The method as claimed in claim 1, further comprising determining a second quality value including an aging behavior, a capacitance, an operating voltage, a quiescent voltage, and/or an internal resistance of the battery cell.

6. The method as claimed in claim 1, wherein the measuring facility includes a laser scanning facility for determining a topological property of the electrode layer.

7. The method as claimed in claim 1, wherein the measuring facility includes a porosity measuring facility for measuring a porosity value of the electrode layer.

8. The method as claimed in claim 7, wherein the porosity value includes a porosity, a pore density, a pore distribution, and/or a pore volume.

9. A method for training an AI engine to analyze an electric paste and/or a electrode layer for a battery cell, the method comprising:
measuring a property of the electrode layer paste and/or the electrode layer using measuring facility;
generating measurement data;
determining a quality valve of the electrode layer paste and/or the electrode layer using AI engine based on the measurement data;
putting
the battery cell into operation;
determining operating data of the battery cell; and
correlating the operating data with the measurement data.

10. The method as claimed in claim 9, wherein two properties of the electrode layer are determined and the first property and the second property are assigned location information during measurement and a comparative value is determined at a location, wherein the comparative value is included in the correlation determination of the AI engine during training.

11. The method as claimed in claim 9, wherein:
the AI engine is trained using deep-learning methods to perform an evaluation of the electrode layer; and
the quality value is divided into quality classes and a quality class is assigned to a location of the electrode layer.

12. A method for producing a battery storage device, the method comprising:
measuring a property of an electrode layer paste and/or an electrode layer using a measuring facility;
generating measurement data; and
determining a quality value of the electrode layer paste and/or the electrode layer using AI engine based on the measurement data; and
adjusting at least one production condition for producing the electrode layer based on the quality value.

13. The production method as claimed in claim 12, wherein the at least one production condition includes temperatures, solvent content of the electrode layer paste, a degree of mixing of the electrode layer paste, and/or an application rate of the electrode layer paste to a carrier substrate.

14-15. (canceled)
